(19) United States
(12) Patent Application Publication
(10) Pub. No.: US 2012/0194076 A1
(43) Pub. Date: Aug. 2, 2012

(54) LIGHTING CONTROL DEVICE

(76) Inventor: Shigeru Murata, Tokyo (JP)

(21) Appl. No.: 13/362,661

(22) Filed: Jan. 31, 2012

(30) Foreign Application Priority Data
Feb. 2, 2011 (JP) 2011-02470

(51) Int. Cl. H05B 37/02

(52) U.S. Cl. 315/119; 315/246

(57) ABSTRACT

The lighting control device provides technology that, by means of a simple configuration, enables the disconnection of a light-emitting element to be detected with high accuracy during PWM dimming. The lighting control device for controlling lighting states of a light-emitting element, includes current supply unit for supplying a current, which is obtained by superimposing a bias current of a predetermined value on a pulse-shaped current whose size periodically fluctuates, to said light-emitting element, and a detection unit which detects a conductive state of said light-emitting element.

### BACKGROUND OF THE INVENTION

1. Field of the Invention

The present invention relates to a lighting control device for controlling the lighting of a light-emitting element.

2. Description of the Background Art

Prior art of a lighting control device which controls lighting of an LED (Light Emitting Diode) or other light-emitting element is disclosed in Japanese Published Unexamined Application No. 2009-266723, for example. The lighting control device of this prior art was devised with the object of detecting disconnection of a light-emitting element with high accuracy when a light-emitting element is subject to DC (Direct current) lighting and PWM (Pulse Width Modulation) dimming. The lighting control device of this prior art comprises a current driving unit which subjects an LED unit to DC (Direct Current) control or PWM control and a disconnection detection unit for detecting disconnection of the LED unit. The disconnection detection unit comprises a latch circuit and a reset unit, wherein the latch circuit outputs a disconnection detection signal after detecting a disconnection for a defined period and the reset unit resets the disconnection detection signal on the basis of the defined condition. The latch circuit comprises a circuit unit in which a resistor element and a capacitor are serially connected, and the capacitor is charged when a signal is output from the disconnection detection unit. Accordingly, after a signal is output from the disconnection detection unit, a time lag can be generated until the disconnection detection signal is output from the latch circuit. And hence it is possible to avoid the outputting of a disconnection detection signal in error while the lighting is off during PWM dimming.

However, due to variations in the characteristics of capacitors in lighting control devices of the prior art, a disconnection detection signal is sometimes output in error (hereinafter referred to as error signal output) during PWM dimming. For example, in cases where an electrolytic capacitor is used as the capacitor, a loss of capacity is generated due to aging, and thus an error signal output is likely to occur. Further, if a ceramic capacitor or the like is used as the capacitor, although aging like that exhibited by an electrolytic capacitor does not occur, since electrostatic capacitance varies due to the ambient temperature, error signal output is likely to occur due to changes in the electrostatic capacitance arising from temperature variations in cases where the required operating temperature range is wide (−40 degrees centigrade to 110 degrees centigrade, for example) such as when the capacitor is used in lighting control of a vehicle lamp, for example.

### SUMMARY OF THE INVENTION

One object of a specific aspect according to the present invention is to provide technology that, by means of a simple configuration, enables the disconnection of a light-emitting element to be detected with high accuracy during PWM dimming.

A lighting control device according to a specific mode of the present invention comprises (a) current supply unit for supplying a current, which is obtained by superimposing a bias current of a predetermined value on a pulse-shaped current whose size periodically fluctuates, to a light-emitting element, and (b) a detection unit which detects a conductive state of the light-emitting element.

According to the foregoing lighting control device, even in periods when the value of the pulse-shaped current is low during PWM control, the light-emitting element is not completely turned OFF and can be placed in a state where a bias current is made to flow. Hence, the detection unit does not erroneously detect disconnection of the light-emitting element. Highly accurate detection of disconnection of the light-emitting element during PWM dimming is therefore possible by way of a simple configuration.

In the foregoing lighting control device, the current supply unit comprises, for instance, (c) a current limiting circuit which is connected between one terminal of the light-emitting element and a reference potential terminal, (d) a switching element which comprises a current I/O terminal and a control terminal and in which the current I/O terminal is connected parallel to the current limiting circuit, (e) and a control signal supply unit which supplies at least a pulse-shaped voltage signal to the control terminal of the switching element.

As described hereinabove, PWM lighting of a light-emitting element is achieved by supplying a pulse-shaped voltage signal to the control terminal of a switching element. Further, even when a switching element is in a non-conductive state in a case where the pulse-shaped voltage signal is at a relatively low level (L level), a state where a bias current flows to a current path which includes a current-limiting circuit can then be achieved.

Moreover, the above-described lighting control device may preferably comprise a switching unit which is connected between the light-emitting element and the power source and which breaks the connection between the light-emitting element and the power source when it is detected by the detection unit that the light-emitting element is in a nonconductive state.

Furthermore, the current-limiting circuit is configured comprising a resistor element, for example. Note that the current-limiting circuit may be a fixed current circuit or a DC/DC converter or the like.

### BRIEF DESCRIPTION OF THE DRAWINGS

FIG. 1 is a circuit diagram showing a configuration of a lighting control device of an embodiment,

FIG. 2A and FIG. 2B are waveform diagrams which schematically shows a current flowing to light-emitting elements.

### DESCRIPTION OF THE PREFERRED EMBODIMENTS

An embodiment of the present invention is now explained with reference to the appended drawings.

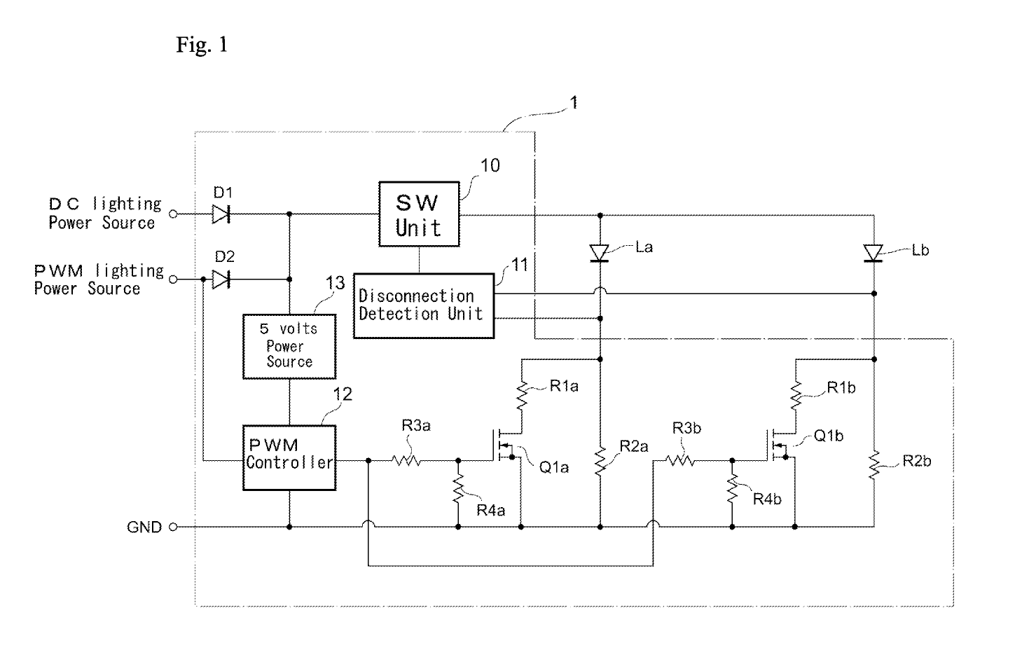

FIG. 1 is a circuit diagram showing a configuration of a lighting control device of an embodiment. The lighting control device 1 shown in FIG. 1 controls the lighting states of light-emitting elements (semiconductor light sources) La, Lb such as LEDs and is configured comprising a switching unit (SW unit) 10, a disconnection detection unit 11, a PWM controller 12, a power source 13, field effect transistors (switching elements) Q1a, Q1b, resistor elements R1a, R1b, R2a, R2b, R3a, R3b, R4a, R4b, and reverse diodes D1 and D2.

The switching unit 10 is connected between each of the light-emitting elements La, Lb and a DC lighting power source and a PWM lighting power source respectively and, when it is detected by the disconnection detection unit 11 that either of the light-emitting elements La and Lb is in a nonconductive state, the switching unit 10 breaks the electrical connection between each of the light-emitting elements La and Lb and the DC lighting power source and the PWM lighting power source.

The disconnection detection unit 11 is connected between each of the light-emitting elements La and Lb and each of the resistor elements R2a and R2b and detects the conductive states of each of the light-emitting elements La and Lb (that is, the presence of a disconnection therein).

The PWM controller 12 receives power from the power source 13 and selectively supplies a pulse-shaped voltage signal or a fixed-value voltage signal to the control terminal (gate) of each of the field-effect transistors Q1a, Q1b. More precisely, the PWM controller 12 outputs a pulse-shaped voltage signal (PWM signal) when the PWM lighting power source is turned ON and outputs a fixed value voltage signal at other times (that is, when the DC lighting power source is ON).

The resistor element R2a is connected between one terminal of the light-emitting element La and a reference potential terminal (the ground terminal GND in this example). Likewise, the resistor element R2b is connected between one terminal of the light-emitting element Lb and the reference potential terminal (the ground terminal GND in this example).

The field effect transistor Q1a comprises two current I/O terminals (source, drain) and one control terminal (gate) and the current I/O terminals are each connected parallel to the resistor element R2a. Similarly, the field effect transistor Q1b comprises two current I/O terminals (source, drain) and one control terminal (gate) and the current I/O terminals are each connected parallel to the resistor element R2b.

The resistor element R1a is serially connected to the field effect transistor Q1a and connected parallel to the resistor element R2a. Similarly, the resistor element R1b is serially connected to the field effect transistor Q1b and connected parallel to the resistor element R2b.

The resistor element R3a is connected between the PWM controller 12 and the control terminal of the field effect transistor Q1a. Similarly, the resistor element R3b is connected between the PWM controller 12 and the control terminal of the field effect transistor Q1b. In this embodiment, respective first terminals, on the PWM controller 12 side, of each of the resistor elements R3a and R3b are connected to one another.

The resistor element R4a is connected between the control terminal of the field effect transistor Q1a and the reference potential terminal (the ground terminal GND in this example). Similarly, the resistor element R4b is connected between the control terminal of the field effect transistor Q1b and the reference potential terminal (the ground terminal GND in this example).

The lighting control device according to the embodiment comprises such a configuration and the operation thereof will be described in detail next.

First, a case where the light-emitting elements La and Lb are each subjected to DC lighting will be described. When a voltage is supplied from the DC lighting power source, the voltage is applied to each of the light-emitting elements La and Lb via the reverse diode D1 and the switching unit 10. Furthermore, a fixed value voltage signal is supplied to the control terminal of each of the field effect transistors Q1a and Q1b from the PWM controller 12, thereby placing each of the field effect transistors Q1a and Q1b in an ON state (conductive state).

Here, the size of the current flowing to the light-emitting element La is determined by each of the resistor elements R1a and R2a which are used to limit the current. That is, the parallel resistors of each of the resistor elements R1a and R2a are in a state of being connected to the light-emitting element La and the maximum current flows to the light-emitting element La. Similarly, the size of the current flowing to the light-emitting element Lb is determined by each of the resistor elements R1b and R2b which are used to limit the current. In other words, the parallel resistors of each of the resistor elements R1b and R2b are in a state of being connected to the light-emitting element Lb and the maximum current flows to the light-emitting element Lb.

Supposing that at least one of the light-emitting elements La and Lb is disconnected in this state, since no current then flows to the light-emitting element, a disconnection is detected by the disconnection detection unit 11. When a disconnection is detected by the disconnection detection unit 11, the electrical connection between each of the power sources and each of the light-emitting elements La and Lb is broken by the switching unit 10. All the light-emitting elements can therefore be placed in an unlit state.

The operation of a case where the light-emitting elements La and Lb are each subjected to PWM (Pulse Width Modulation) lighting will be described next. Similarly to the above case where DC lighting is performed, when a voltage is supplied from the PWM lighting power source, the voltage is applied to each of the light-emitting elements La and Lb via the reverse diode D2 and the switching unit 10. Further, a pulse-shaped voltage signal (pulse signal) is supplied from the PWM controller 12 to the control terminal of each of the field effect transistors Q1a and Q1b. The field effect transistors Q1a and Q1b each repeat an ON state (conductive state) and an OFF state (nonconductive state) as the voltage value of the pulse signal rises and falls.

When the pulse signal is at a relatively high level (H L level), the field effect transistors Q1a and Q1b each enter an ON state and the maximum current then flows to each of the light-emitting elements La and Lb.

On the other hand, when the pulse signal is at a relatively low level (L level), the field effect transistors Q1a and Q1b each enter an OFF state. Here, although no current flows to the current path which comprises the resistor element R1a and the current path which comprises the resistor element Rib respectively, current does flow to the current path which comprises the resistor element R2a and the current path which comprises the resistor element R2b respectively. In other words, if the field effect transistors Q1a and Q1b are each in an OFF state, the size of the current flowing to each of the light-emitting elements La and Lb is configured by each of the resistor elements R2a and R2b. That is, even in periods when the voltage value of the pulse signal is low during PWM control, light-emitting elements La and Lb are not completely turned OFF and can be placed in a state where a bias current is made to flow. A bias current here is a current of a magnitude on the order of a few microamperes (μA) to several tens of milliampere (mA), for example.

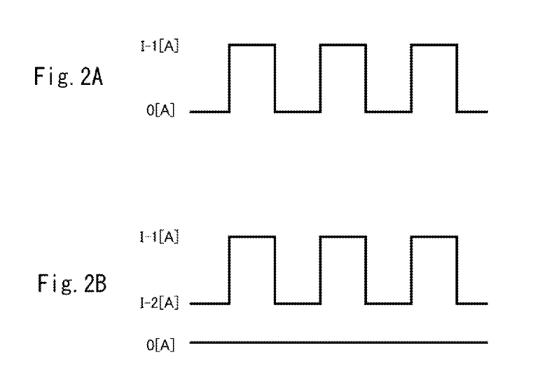

FIG. 2A and FIG. 2B are waveform diagrams which schematically shows a current flowing to light-emitting elements. Conventionally, as shown in FIG. 2A, a state is assumed where a current I-1 flows to the light-emitting element when same is lit and no current flows when the light-emitting element is not lit (current=0). Hence, disconnections are sometimes detected in error in periods when the current is 0. However, in this embodiment, as shown in FIG. 2B, the current I-1 flows to the light-emitting element when same is lit and a bias current I-2 which is lower than current I-1 flows when the light-emitting element is not lit. In other words, the lighting control device of this embodiment always passes the bias current I-2, and a driving waveform for performing PWM lighting is superimposed on the current. Hence, the disconnection detection unit 11 does not erroneously detect disconnection of the light-emitting elements. Note that, supposing that at least one of the light-emitting elements La and Lb is disconnected, current does not flow to the light-emitting element and disconnection is detected by the disconnection detection unit 11.

Note that this invention is not limited to the subject matter of the foregoing embodiment, and can be implemented by being variously modified within the scope of the gist of the present invention. For example, although two light-emitting elements are subjected to lighting control in the above embodiment, the number of light-emitting elements is not limited to two. Further, although field-effect transistors have been cited as an example of current control elements, other elements (bipolar transistors or the like, for example) may also be used.

Moreover, although a circuit comprising resistor elements was described as an example of a current limiting circuit in the above embodiment, the current limiting circuit is not limited to such a circuit and may instead be a fixed current circuit or a fixed current DC/DC converter or the like, for example.

What is claimed is:

1. A lighting control device for controlling lighting states of a light-emitting element, comprising:
current supply unit for supplying a current, which is obtained by superimposing a bias current of a predetermined value on a pulse-shaped current whose size periodically fluctuates, to said light-emitting element; and
a detection unit which detects a conductive state of said light-emitting element.

2. The lighting control device according to claim 1,
wherein said current supply unit comprises:
a current limiting circuit which is connected between one terminal of said light-emitting element and a reference potential terminal;
a switching element which comprises a current I/O terminal and a control terminal and in which said current I/O terminal is connected parallel to said current limiting circuit; and
a control signal supply unit which supplies at least a pulse-shaped voltage signal to the control terminal of said switching element.

3. The lighting control device according to claim 2,
wherein the current limiting circuit comprises a resistor element.

4. The lighting control device according to claim 3, comprising:
a switching unit which is connected between said light-emitting element and a power source and which breaks the connection between said light-emitting element and said power source when it is detected by the detection unit that said light-emitting element is in a nonconductive state.

5. A lighting control device for controlling lighting states of a light-emitting element, comprising:
current supply unit for supplying a current, which is obtained by superimposing a bias current of a predetermined value on a pulse-shaped current whose size periodically fluctuates, to said light-emitting element; and
a detection unit which detects a conductive state of said light-emitting element;
wherein said current supply unit comprises:
a current limiting circuit which is connected between one terminal of said light-emitting element and a reference potential terminal;
a switching element which comprises a current I/O terminal and a control terminal and in which said current I/O terminal is connected parallel to said current limiting circuit; and
a control signal supply unit which supplies at least a pulse-shaped voltage signal to the control terminal of said switching element;
and the lighting control device further comprising:
a switching unit which is connected between said light-emitting element and a power source and which breaks the connection between said light-emitting element and said power source when it is detected by the detection unit that said light-emitting element is in a nonconductive state.
